(19) United States
(12) Patent Application Publication
(10) Pub. No.: US 2023/0289490 A1
(43) Pub. Date: Sep. 14, 2023

(54) UNDERGROUND STRUCTURE DETECTION APPARATUS AND UNDERGROUND STRUCTURE DETECTION METHOD

(71) Applicant: HITACHI, LTD., Tokyo (JP)

(72) Inventors: Takashi Kanemaru, Tokyo (JP); Xiaorui Qiao, Tokyo (JP)

(73) Assignee: HITACHI, LTD., Tokyo (JP)

(21) Appl. No.: 18/169,355

(22) Filed: Feb. 15, 2023

(30) Foreign Application Priority Data
Mar. 14, 2022 (JP) 2022-039763

(51) Int. Cl. G06F 30/18

(52) U.S. Cl. CPC G06F 30/18; G06F 2113/14

(57) ABSTRACT

An underground structure detection apparatus detects information including position/posture information based on a plurality of pieces of two-dimensional data indicating a cross section of the ground and three-dimensional data indicating the underground structure. Synthetic data is obtained by synthesizing the two-dimensional data and the three-dimensional data, and position/posture information of a component is corrected based on an image from the two-dimensional data. When a determination is made in a transverse direction with respect to a road, and the image feature is included in continuous images by a threshold or more, it is determined as a transverse pipe, and when a determination is made in a longitudinal direction with respect to a road, and the image feature is included in continuous images by a threshold or less, it is determined as a longitudinal pipe, and the posture is corrected for each direction.

### BACKGROUND OF THE INVENTION

### 1. Field of the Invention

The present invention relates to an underground structure detection apparatus and an underground structure detection method, and more particularly to an underground structure detection apparatus and an underground structure detection method suitable for accurately detecting an underground buried object detected by a radar.

### 2. Description of the Related Art

In recent years, the use of underground spaces has been actively promoted by redevelopment of cities or implementation of pole-less measures. In the underground space, buried objects such as a water pipe, a gas pipe, a communication line, and an electric wire exist, and it is required to investigate the buried objects before starting construction such as water supply and electric construction. In the investigation of the underground space, an investigation by a ground radar that can investigate without excavating the ground is performed.

A technique for measuring an underground buried object by a radar from a road is disclosed in, for example, JP 2015-90345 A. A three-dimensional under-road surface diagnosis system described in JP 2015-90345 A irradiates a radar from a mobile object such as a vehicle and explores under a road surface. Furthermore, a road surface state is measured by a camera or a laser scanner. Then, by acquiring three-dimensional position information of the mobile object with high accuracy and adding the three-dimensional position information to the road surface state measurement data and the under-road exploration data, the information can be integrated and utilized as integrated data.

Furthermore, in order to detect components located deep in the ground, a method of generating a three-dimensional model of an underground structure on the basis of a plurality of radar images and clarifying the components located deep in the ground is conceivable.

For example, JP 2019-109747 A discloses a technique for estimating the position and posture of an object by 3D data and a 2D image. In a position/posture estimation device described in JP 2019-109747 A, three-dimensional coordinates of an object are acquired by a 3D sensor, a first position/posture estimation unit optimizes 6 parameters (translation x, y, z and rotation φ, γ, θ) using the 3D data, and on the basis of the result, a second position/posture estimation unit 146 optimizes only 3 parameters (translation x, y and rotation θ) that can be accurately estimated in a 2D image.

### SUMMARY OF THE INVENTION

According to the three-dimensional under-road surface diagnosis system described in JP 2015-90345 A, a positional relationship between the road surface state and the under-road surface state can be accurately grasped by integrating a road surface state camera image, road surface state three-dimensional point group data, and depth direction information. However, the three-dimensional under-road surface diagnosis system described in JP 2015-90345 A does not have a function of determining the position and posture of the components of the underground structure.

In the exploration by the ground radar, it is conceivable that the components located deeper in the ground may not clearly displayed in a radar image. Therefore, in the detection of the underground structure using only the radar image, it is limited to detecting components near the road surface.

The technique described in JP 2019-109747 A is a technique of optimizing a three-dimensional model by two-dimensional image information to accurately obtain a posture of an object. However, due to a distance measuring method, for example, only a frontmost subject can be measured, and the distance measuring method cannot be directly applied to underground investigation.

An object of the present invention is to provide an underground structure detection apparatus and an underground structure detection method capable of accurately detecting an underground buried object detected by a radar.

A feature of the underground structure detection apparatus of the present invention is preferably an underground structure detection apparatus that detects information including a component constituting an underground structure, a type of the component, and position/posture information based on a plurality of pieces of two-dimensional data indicating a cross section of ground and three-dimensional data indicating the underground structure, in which with respect to synthetic data obtained by synthesizing the two-dimensional data and the three-dimensional data, the position/posture information of a component represented by the synthetic data is corrected based on an image feature grasped from the two-dimensional data.

According to the present invention, it is possible to provide an underground structure detection apparatus and an underground structure detection method capable of accurately detecting an underground buried object detected by a radar.

### BRIEF DESCRIPTION OF THE DRAWINGS

FIG. 1 is a diagram illustrating a schematic configuration of an underground structure detection apparatus and a state of detecting an underground structure;

FIG. 2 is a diagram illustrating a hardware and software configuration of the underground structure detection apparatus;

FIGS. 3A to 3E are diagrams for explaining measurement data and blueprint data;

FIG. 4 is a schematic flowchart illustrating a series of processing from acquisition of measurement data and blueprint data to an output of analysis results of a component by the underground structure detection apparatus;

FIG. 5 is a flowchart illustrating details of three-dimensional model generation/component classification processing;

FIG. 6 is a flowchart illustrating position/posture estimation processing of a component;

FIG. 7 is a flowchart illustrating correction processing by two-dimensional data according to a first embodiment;

FIG. 8A is a diagram explaining an image feature in a transverse pipe;

FIG. 8B is a diagram explaining an image feature in a longitudinal pipe;

FIG. 9 is a flowchart illustrating details of component specifying processing for component composite information;

FIG. 10 is a diagram explaining a specific flow of component composite information and component type/position information;

FIG. 11 is a flowchart illustrating discriminating processing of a different type pair of components;

FIG. 12 is a diagram illustrating an example of a component information display screen; and

FIG. 13 is a flowchart illustrating correction processing by two-dimensional data according to a second embodiment.

### DESCRIPTION OF THE PREFERRED EMBODIMENTS

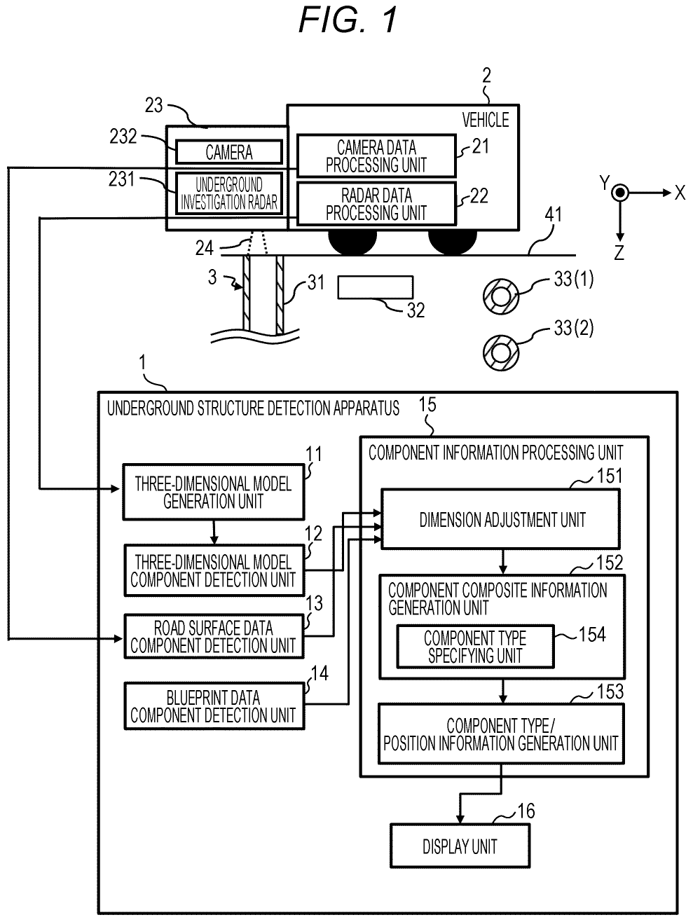

Hereinafter, each embodiment according to the present invention will be described with reference to FIGS. 1 to 13.

### First Embodiment

Hereinafter, a first embodiment of the present invention will be described with reference to FIGS. 1 to 12.

Note that an underground structure in the present embodiment refers to a structure (state, position) in an underground space including a buried object such as a water pipe, a gas pipe, a communication line, or an electric wire buried under the ground and an underground cavity. Furthermore, a component refers to an element constituting the underground structure. That is, the component is, for example, a buried object such as a water pipe, a gas pipe, a communication line, or an electric wire buried under the ground, an underground cavity, or the like.

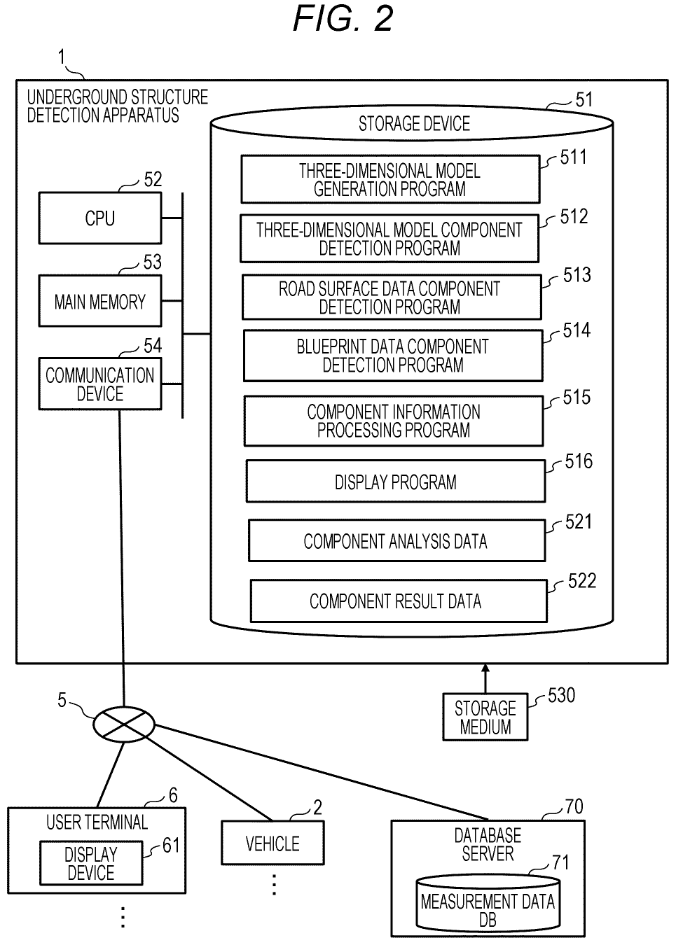

First, a configuration of an underground structure detection apparatus will be described with reference to FIGS. 1 and 2.

Note that, in the following description, as a three-dimensional coordinate system, a direction in which a vehicle moves (road direction) is taken as an X-axis direction, a width direction of the vehicle (width direction of a road) is taken as a Y-axis direction, and a depth direction of the ground (vertically downward direction) is taken as a Z-axis direction.

An underground structure detection apparatus 1 illustrated in FIG. 1 is an apparatus that detects an underground structure and outputs information (additional information regarding a position, a size, and other components) of the detected underground structure to a user. That is, the underground structure detection apparatus 1 detects the underground structure on the basis of, for example, measurement data of the underground structure acquired from the vehicle 2 provided with an underground investigation radar. For example, the underground structure detection apparatus 1 displays information of the detected underground structure on a display device (described later with reference to FIG. 2).

As illustrated in FIG. 2, the underground structure detection apparatus 1 is connected to a vehicle 2, a database server 70, and a user terminal 6 via a network 5.

Note that the underground structure detection apparatus 1 is not limited to acquiring the measurement data of the underground structure from the vehicle 2, and may acquire the measurement data of the underground structure from a device such as a hand-held underground investigation radar that can be moved by human power or a portable underground investigation radar.

The vehicle 2 travels in a direction of a road and continuously measures an underground space and a road surface 41 by means of a measurement device 23 as illustrated in FIG. 1. The measurement device 23 includes an underground investigation radar 231 and a camera 232. A plurality of the underground investigation radars 231 are provided in the width direction of the vehicle 2, and continuously measure the underground space by irradiating radars 24 in the Z-axis direction.

For example, the underground investigation radars 231 measure components 3, that is, a manhole 31, a cavity 32, and a water pipe 33 (in the illustration according to FIG. 1, a water pipe 33(1) and a water pipe 33(2)) as the vehicle 2 moves. Both the water pipe 33(1) and the water pipe 33(2) are transverse pipes (described later) with respect to the road, and the water pipe 33(2) is located at a position (that is, a deeper position in the ground) where the Z coordinate is larger than that of the water pipe 33(1). Measurement data of the underground space of the underground investigation radars 231 is wirelessly sent to the underground structure detection apparatus 1 by a radar data processing unit 22.

Furthermore, the camera 232 included in the measurement device 23 continuously captures an image of the road surface 41. In the captured image, for example, the manhole 31 seen on the road surface 41 is displayed. The captured image of the road surface is wirelessly sent to the underground structure detection apparatus 1 by a camera data processing unit 21.

As illustrated in FIG. 1, the underground structure detection apparatus 1 includes a three-dimensional model generation unit 11, a three-dimensional model component detection unit 12, a road surface data component detection unit 13, a blueprint data component detection unit 14, a component information processing unit 15, and a display unit 16.

The three-dimensional model generation unit 11 is a functional unit that generates a three-dimensional model (A specific image will be described later.) indicating an underground structure on the basis of measurement data of the underground investigation radars 231.

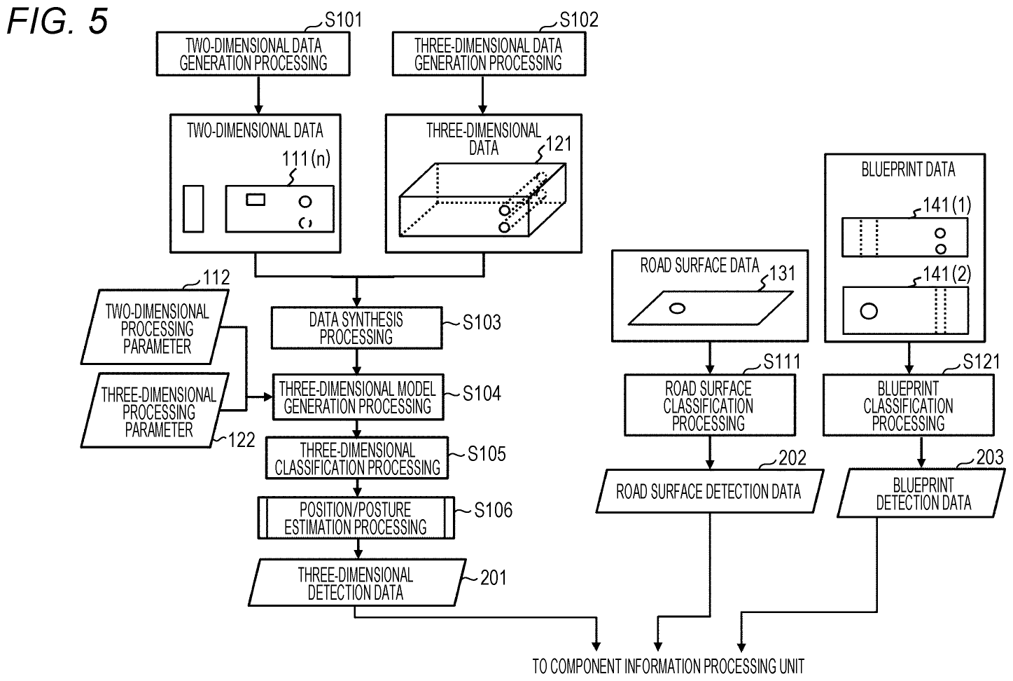

The three-dimensional model component detection unit 12 is a functional unit that detects a component constituting an underground structure on the basis of the three-dimensional model generated by the three-dimensional model generation unit 11. Three-dimensional detection data 201 (described later with reference to FIG. 5) as an example of a detection result of the three-dimensional model component detection unit 12 includes, for example, type information, position information, or shape information of the component. The three-dimensional model component detection unit 12 sends the three-dimensional detection data 201 to the component information processing unit 15.

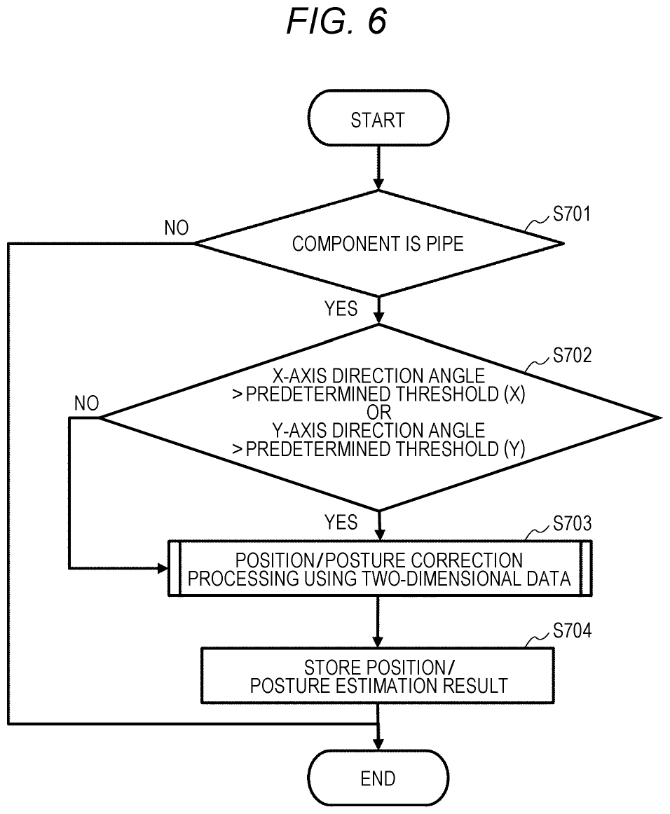

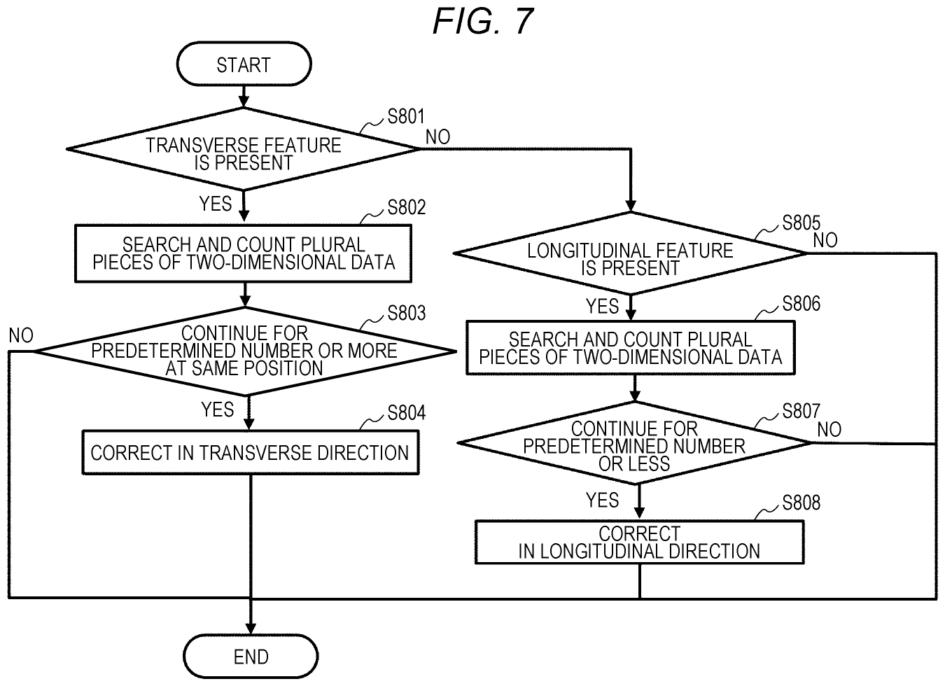

Details of the processing in which the three-dimensional model component detection unit 12 generates the position information and the shape information of the component will be described later with reference to FIGS. 6 and 7.

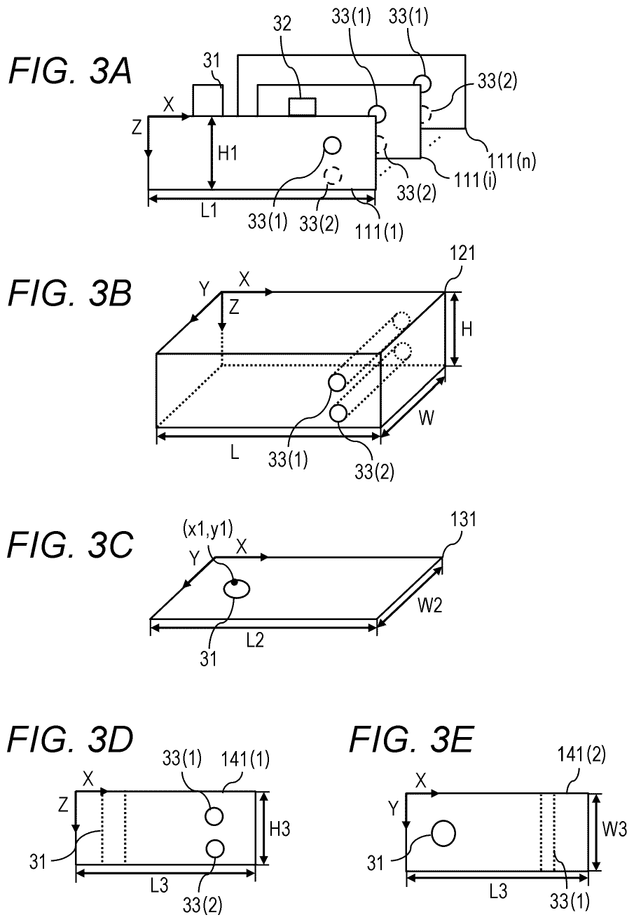

The road surface data component detection unit 13 is a functional unit that detects a component on the road surface based on road surface data 131 (to be described later with reference to FIGS. 3A to 3E) acquired from the camera data processing unit 21 by photographing the road surface 41.

The road surface data component detection unit 13 detects the manhole 31 from the road surface data 131, for example. Road surface detection data 202 (described later with reference to FIG. 5) as an example of a detection result of the road surface data component detection unit 13 includes, for example, type information, position information, or shape information of the component on the road surface. The road surface data component detection unit 13 transmits the road surface detection data 202 to the component information processing unit 15.

The blueprint data component detection unit 14 is a functional unit that detects a component illustrated in blueprint data 141 (described later with reference to FIGS. 3D and 3E).

The blueprint data component detection unit 14 acquires the blueprint data 141 (In the illustration according to FIGS. 3D and 3E, 141(1) and 141(2)) of the underground structure.

The blueprint data 141 may be a digitized blueprint of a paper medium. For example, the user may digitize the blueprint of the paper medium by a scanner or the like, and input the digitized blueprint data 141 to the blueprint data component detection unit 14.

A detection result (blueprint detection data 203 illustrated in FIG. 5) of the blueprint data component detection unit 14 includes a type, position, or shape of a component illustrated in the blueprint. The blueprint data component detection unit 14 transmits the blueprint detection data 203 to the component information processing unit 15.

Note that the blueprint data component detection unit 14 may have an optical character recognition/reader (OCR) function to detect the blueprint detection data 203 from character information illustrated in the blueprint. In a case where the blueprint data 141 is composed of characters, the blueprint data component detection unit 14 may generate a type and a position of a component as visually recognizable image data.

The component information processing unit 15 is a functional unit that processes information regarding the detected component, and is a functional unit that analyzes the three-dimensional detection data 201, the road surface detection data 202, and the blueprint detection data 203, and finally outputs the type and position information of the component.

The component information processing unit 15 includes, as sub-functional units, a dimension adjustment unit 151, a component composite information generation unit 152, and a component type/position information generation unit 153.

The dimension adjustment unit 151 is a functional unit that converts dimensions of the three-dimensional data, the road surface data, and the blueprint data as necessary. Note that details of each data will be described later.

For example, the dimension adjustment unit 151 converts the dimensions of the road surface data 131 and the blueprint data 141 based on the dimension of the three-dimensional data 121. The dimension adjustment unit 151 sends the three-dimensional data 121, the road surface data 131, and the blueprint data 141 after the dimension adjustment to the component composite information generation unit 152.

The component composite information generation unit 152 is a functional unit that generates composite information regarding a component. The component composite information is information for integrating and evaluating three-dimensional data, road surface data, and blueprint data, which are expressed separately for one component. The component composite information generation unit 152 includes a component type specifying unit 154 as a sub-functional unit. The component type specifying unit 154 is a functional unit that specifies the type of the component from a pair of the components included in the component composite information. For example, the component type specifying unit 154 calculates an evaluation index on the basis of a size of an overlapping region of the component pair and specifies the type of the component on the basis of the evaluation index. Details of the processing of specifying the type of the component by each evaluation index will be described later.

The component composite information generation unit 152 compares the evaluation index with a predetermined threshold by the component type specifying unit 154 to determine whether the component pair indicate the same component, and sends the component composite information (related information between the type of the component and the data) classified as the component as a result to the component type/position information generation unit 153.

The component type/position information generation unit 153 is a functional unit that generates a type (manhole, cavity, water pipe, etc.) for each component and position information in a three-dimensional coordinate system thereof from the component composite information.

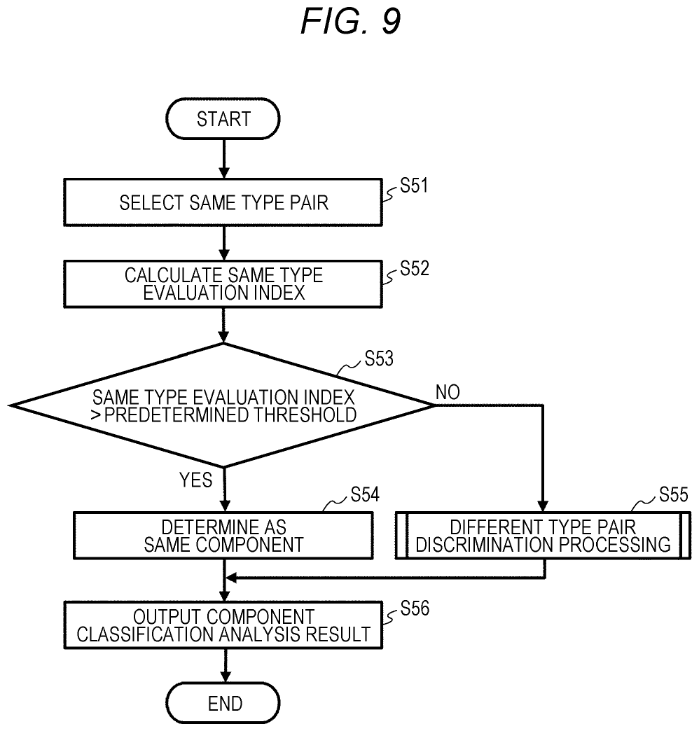

The component type/position information generation unit 153 transmits the type and position information of the component to the display unit 16 as component result data 522. Note that details of the processing of the component information processing unit 15 will be described later with reference to FIGS. 9 to 11.

The display unit 16 is a functional unit that displays the type of the component and the position information of the component as a detection result of the underground structure detection apparatus 1. The display unit 16 displays the component result data 522 of the component information processing unit 15 on a display device such as a display monitor.

Next, a hardware configuration and a software configuration of the underground structure detection apparatus will be described with reference to FIG. 2.

For example, as illustrated in FIG. 2, the underground structure detection apparatus 1 includes a storage device 51, a central processing unit (CPU) 52, a main memory 53, and a communication device 54, which are connected by a bus.

The storage device 51 is a device that stores data with a large capacity, such as a hard disk drive (HDD) of a magnetic storage medium and a solid state drive (SDD) of a nonvolatile semiconductor device storage medium. In the storage device 51, for example, a three-dimensional model generation program 511, a three-dimensional model component detection program 512, a road surface data component detection program 513, a blueprint data component detection program 514, a component information processing program 515, and a display program 516 are installed.

The three-dimensional model generation program 511, the three-dimensional model component detection program 512, the road surface data component detection program 513, the blueprint data component detection program 514, the component information processing program 515, and the display program 516 are programs that realize the functions of the three-dimensional model generation unit 11, the three-dimensional model component detection unit 12, the road surface data component detection unit 13, the blueprint data component detection unit 14, the component information processing unit 15, and the display unit 16, respectively.

Furthermore, the storage device 51 of the underground structure detection apparatus 1 holds component analysis data 521 and the component result data 522.

The component analysis data 521 is intermediate data calculated when the component is analyzed based on the measurement data. The component result data 522 is data including the type of the component finally displayed to the user and the coordinate position of the three-dimensional coordinates.

Note that the program may be recorded in a storage medium 530 such as a universal serial bus (USB) memory.

The CPU 52 implements each function by reading each program installed in the storage device 51 into the main memory 53 and executing the program. The main memory 53 is, for example, a volatile storage medium such as a random access memory (RAM).

The communication device 54 is connected to the vehicle 2, the database server 70, and the user terminal 6 via the network 5 so as to be capable of bidirectional communication. The network 5 may be a wireless connection or a wired connection as a connection form.

The user terminal 6 is an information processing terminal including a display device 61, and is, for example, a portable terminal such as a smartphone or a personal computer (PC). Note that the display device 61 is not limited to being provided in the user terminal 6, and may be provided in the underground structure detection apparatus 1 and connected via a display interface to display an image.

The database server 70 is a server device that stores measurement data collected by the vehicle 2 in a measurement data DB 71 and provides a function of accessing from the outside. A data transfer from the vehicle 2 to the database server 70 may be sequentially processed via the network 5, for example, or may be transferred at regular intervals and batch processed.

Furthermore, the measurement data may be stored in the storage device 51 of the underground structure detection apparatus 1 in addition to the form of being stored in the external device in this manner.

Next, a data structure used in the underground structure detection apparatus will be described with reference to FIGS. 3A to 3E.

FIG. 3A illustrates an example of two-dimensional data as measurement data obtained from the underground investigation radars 231.

The three-dimensional model generation unit 11 generates a plurality of pieces of two-dimensional data 111 by performing coloring processing on the measurement data acquired from the radar data processing unit 22 of the vehicle 2.

For example, the three-dimensional model generation unit 11 sets a length H1 in the height direction (Z-axis direction) and a length L1 in the lateral direction (X-axis direction) for each piece of two-dimensional data 111. For example, as setting values of each piece of two-dimensional data 111, a length H1, a length L1, and the number n of each piece of two-dimensional data 111 are stored in the storage device 51 as the component analysis data 521.

Furthermore, the three-dimensional model generation unit 11 stores a two-dimensional processing parameter 112 (described later with reference to FIG. 5) used when generating the two-dimensional data 111. The two-dimensional processing parameter is a parameter describing a property of the two-dimensional data, and is, for example, an intensity value of coloring, a setting value of sensitivity of a receiver, a relative permittivity, or the like.

Each piece of two-dimensional data 111 is data for displaying a cross section of the ground. Each piece of two-dimensional data 111 is generated for each of the underground investigation radars 231. That is, each piece of the two-dimensional data 111(1) to 111(n) is generated corresponding to each of the n underground investigation radars 231. Note that each piece of two-dimensional data 111(i) is illustrated as corresponding to the i-th (i=1, . . . , n) underground investigation radar 231 as viewed from the front side of the vehicle 2 (the side where the value of Y in the Y-axis direction is large).

In the two-dimensional data 111(1), for example, the water pipe 33(1) and the water pipe 33(2) are displayed as images. For a certain i, for example, the manhole 31, the cavity 32, and the water pipes 33(1) and 33(2) are displayed in the two-dimensional data 111(i). In the two-dimensional data 111(i), for example, the water pipe 33(1) and the water pipe 33(2) are displayed. Since the radar 24 is irradiated from the road surface 41, the water pipe 33(2) displayed in the two-dimensional data 111(1) is less clear than the water pipe 33(1).

Next, FIG. 3B illustrates an example of three-dimensional data as measurement data obtained from the underground investigation radars 231.

The three-dimensional model generation unit 11 generates the three-dimensional data 121 from the measurement data of the underground investigation radars 231 by using synthetic aperture processing.

Note that the synthetic aperture processing is a technique for acquiring high-resolution information using a plurality of receivers.

For example, the three-dimensional model generation unit 11 sets a length H in the height direction (Z-axis direction), a length L in the lateral direction (X-axis direction), and a length W in the depth direction (Y-axis direction) for each piece of three-dimensional data 121. For example, the three-dimensional model generation unit 11 stores the length H, the length L, and the length W as the setting values of the three-dimensional data 121 in the storage device 51 as the component analysis data 521.

Furthermore, the three-dimensional model generation unit 11 stores a three-dimensional processing parameter 122 (described later with reference to FIG. 5) used when generating the three-dimensional data 121. The three-dimensional processing parameter 122 is a parameter describing a property of the three-dimensional data, and is, for example, a value used when generating three-dimensional data such as an intensity value of coloring, a setting value of sensitivity of a receiver, or a relative permittivity.

The three-dimensional data 121 is data representing the underground structure by three-dimensional coordinates. The three-dimensional data 121 shows, for example, the water pipe 33(1) and the water pipe 33(2). Note that, although not illustrated in the three-dimensional data 121, the manhole 31 and the cavity 32 may be indicated in the example of the present embodiment.

Next, FIG. 3C illustrates an example of road surface data as measurement data obtained from the camera 232.

The road surface data component detection unit 13 acquires the road surface data 131 from the camera data processing unit 21. In the road surface data 131, for example, a length L2 in the lateral direction and a length W2 in the depth direction are set. The road surface data component detection unit 13 stores the length L2 and the length W2 as setting values of the road surface data 131 in the storage device 51 as the component analysis data 521. The road surface data 131 is data indicating the state of the road surface, and the manhole 31 is expressed by the road surface data 131, for example.

Next, FIGS. 3D and 3E illustrate an example of blueprint data generated by the blueprint related information generation unit.

The blueprint data 141(1) corresponds to a side view, and a length L3 in the lateral direction and a length H3 in the height direction are set, for example. The blueprint data component detection unit 14 stores the length H3 and the length L3 as setting values of the blueprint data 141(1) in the storage device 51 as the component analysis data 521.

The blueprint data 141(2) corresponds to a top view, and for example, a length L3 in the lateral direction and a length W3 in the depth direction are set. The blueprint data component detection unit 14 stores the length L3 and the length W3 as dimensions of the blueprint data 141(2) in the storage device 51 as component analysis data 521.

The blueprint data 141(1) is data indicating a blueprint of the component 3 when the underground space is viewed from the front side, and the blueprint data 141(1) indicates, for example, the manhole 31, the water pipe 33(1), and the water pipe 33(2). The blueprint data 141(2) is data indicating a blueprint of the component 3 when the underground space is viewed from the road surface side (Z-axis direction), and the blueprint data 141(2) indicates, for example, the manhole 31 and the water pipe 33(1).

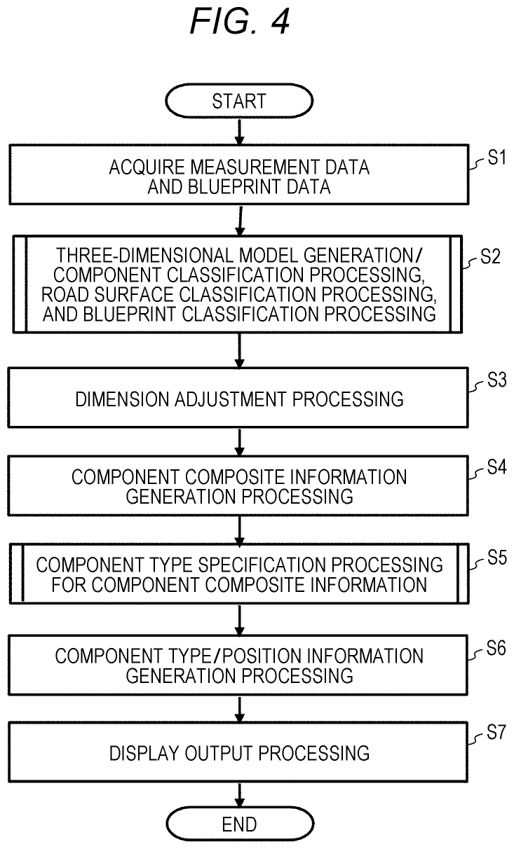

Next, processing performed by the underground structure detection apparatus will be described with reference to FIGS. 4 to 11.

First, a series of processing from acquisition of measurement data and blueprint data to an output of analysis results of a component by the underground structure detection apparatus will be described with reference to FIG. 4.

First, the three-dimensional model generation unit 11 and the road surface data component detection unit 13 of the underground structure detection apparatus 1 acquire measurement data from the vehicle 2, and the blueprint data component detection unit 14 acquires the blueprint data 141 of the underground structure (S1).

In step (S1), the three-dimensional model generation unit 11 acquires the two-dimensional data 111 and the three-dimensional data 121 as the measurement data.

Next, the three-dimensional model generation unit 11 of the underground structure detection apparatus 1 generates a three-dimensional model from the two-dimensional data and the three-dimensional data, and the three-dimensional model component detection unit 12, the road surface data component detection unit 13, and the blueprint data component detection unit 14 detect a component based on the three-dimensional model, a component based on the road surface data, and a component based on the blueprint data, respectively, and transmit them to the component information processing unit 15 as the three-dimensional detection data 201, the road surface detection data 202, and the blueprint detection data 203 (S2).

Note that details of step (S2) will be described later with reference to FIG. 5.

Next, the dimension adjustment unit 151 of the component information processing unit 15 causes the dimensions of the three-dimensional detection data 201, the road surface detection data 202, and the blueprint detection data 203 to correspond to each other (S3).

Details of the dimension adjusting unit will be described later.

Next, the component composite information generation unit 152 of the component information processing unit 15 generates component composite information of the three-dimensional detection data 201, the road surface detection data 202, and the blueprint detection data 203 (S4).

Next, the component composite information generation unit 152 of the component information processing unit 15 specifies the type of the component for the component composite information of the three-dimensional detection data 201, the road surface detection data 202, and the blueprint detection data 203 (S5).

The component type specifying processing for the component composite information will be described later in detail with reference to FIGS. 9 to 11.

Next, the component type/position information generation unit 153 generates the type and position information of the component from the component composite information as the analysis result of the component (S6).

Note that the component type/position information generation unit 153 may determine again that a plurality of components determined to be different components in the component specifying processing (S5) of the component composite information are the same component.

That is, for example, in a case where a plurality of components determined to be different components are connected in series, the component type/position information generation unit 153 determines that the components are the same component. For example, in a case where a water pipe oblique to the X-axis direction and a water pipe along the Y-axis direction are detected by the component composite information generation unit 152, the component type/positional information generation unit 153 may detect, for example, a point where a water pipe oblique to the X-axis direction and a water pipe along the Y-axis direction are connected, and determine that the point is one water pipe.

Next, the display unit 16 displays and outputs a screen including the type and position information of the component 3 (S7).

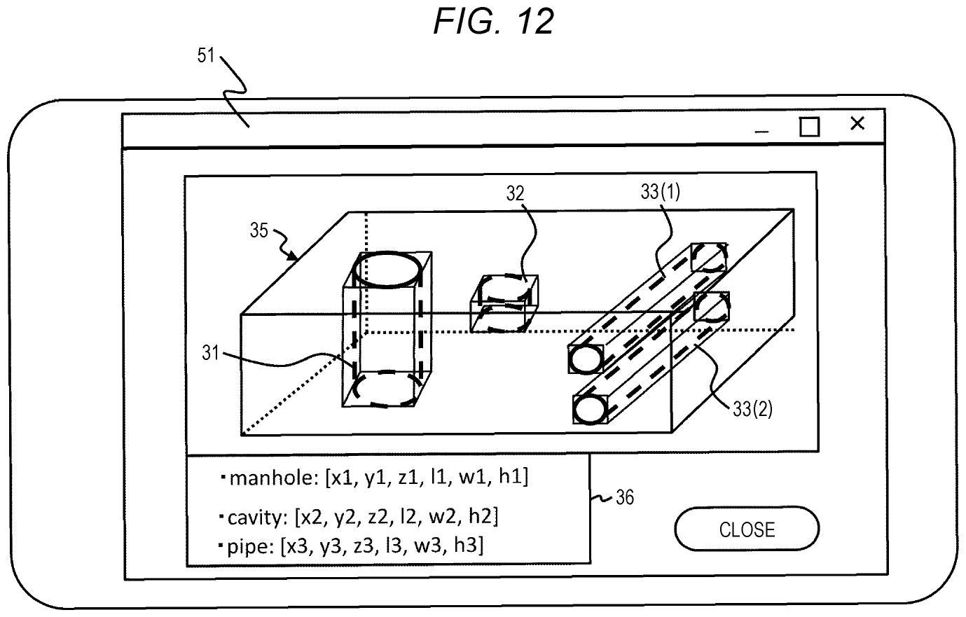

The screen displayed by the display unit 16 will be described later in detail with reference to FIG. 12.

Next, the three-dimensional model generation/component classification processing, the road surface classification processing, and the blueprint classification processing will be described in detail with reference to FIG. 5.

This processing corresponds to S2 in FIG. 4.

First, the three-dimensional model generation unit 11 generates the two-dimensional data 111 by displaying the cross section of the ground in gray scale according to an amplitude of a reflected wave of the underground investigation radar 231 of the radar 24 (S101).

The two-dimensional data 111(1), . . . , the two-dimensional data 111(i), . . . , and the two-dimensional data 111(n) (n is a predetermined integer, and i is an integer satisfying 1≤i≤n.) as illustrated in FIG. 3A are, for example, image data indicating a cross section of the ground colored according to the amplitude of the reflected wave of the radar 24. As the coloring processing, for example, the color on a white side is colored as the amplitude of the reflected wave of the radar increases.

Note that the two-dimensional data generation processing may include processing of acquiring clear image data of the two-dimensional data 111, and for example, image processing such as noise removal or edge enhancement may be performed by filtering the two-dimensional data 111.

Furthermore, the three-dimensional model generation unit 11 generates the three-dimensional data 121 by using the synthetic aperture processing for the measurement data measured for each of the underground investigation radars 231 (S102).

Note that the three-dimensional data generation processing may include processing of acquiring clear image data. For example, image processing such as noise removal or edge enhancement may be performed by applying a filter to the three-dimensional data 121.

Next, the three-dimensional model generation unit 11 synthesizes the two-dimensional data 111 and the three-dimensional data 121 (S103). In the data synthesis processing S103, the three-dimensional model generation unit 11 adjusts the dimension of each piece of two-dimensional data 111 on the basis of (Formula 1) and (Formula 2) described below, for example.

L1=s1*L (Formula 1)

H1=s2*H (Formula 2)

s1 and s2 are scales indicating a correspondence relationship between the three-dimensional data 121 and the two-dimensional data 111. That is, s1 is the magnification in the lateral direction of the three-dimensional data 121 and the two-dimensional data 111, and s2 is the magnification in the longitudinal direction of the three-dimensional data 121 and the two-dimensional data 111.

After performing the dimensional adjustment of the two-dimensional detection data and the three-dimensional data, the three-dimensional model generation unit 11 may set the luminance value of the point at which the position information matches as an intermediate value between the two-dimensional detection data and the three-dimensional data. Alternatively, for example, a predetermined ratio value a may be determined, and the luminance values may be synthesized by a calculation formula such as (luminance value of certain coordinate)=a×luminance value of three-dimensional data+(1−a)×luminance value of two-dimensional data such that a synthesis result of the luminance values of both sides does not exceed the original maximum value. Alternatively, both pieces of data in the grayscale format may be newly assigned (For example, R represents the luminance value of the three-dimensional data, G represents the luminance value of the two-dimensional data, and B represents 0.) to one of the RGB channels of the color pixel.

Next, the three-dimensional model generation unit 11 generates a three-dimensional model (S104). For example, the three-dimensional model is generated by learning in advance the three-dimensional data for learning as teacher data, the two-dimensional processing parameter for learning used in generating the three-dimensional data for learning, and the three-dimensional processing parameter for learning.

The three-dimensional model is, for example, a learning model for predicting to which type the component in the three-dimensional data belongs based on the three-dimensional data and the three-dimensional processing parameter.

The three-dimensional model component detection unit 12 classifies the components indicated by the synthetic data by inference based on the generated three-dimensional model (S105). That is, by the inference function of AI using the three-dimensional model, a type in which the component in the three-dimensional model is relatively likely to be applicable among the manhole 31, the cavity 32, or the water pipe 33(1), the water pipe 33(2) is predicted.

Note that the three-dimensional model may be generated by learning in advance.

Next, the three-dimensional model component detection unit 12 performs position/posture estimation processing of estimating shape information including position information and directions/postures of the classified components (S106). That is, as the position/posture estimation processing, the two-dimensional data 111 and the information on the classified components are read from the main memory 43, and the position/posture estimation process is repeatedly performed.

Note that details of the position/posture estimation processing will be described later with reference to FIG. 6.

On the other hand, the road surface data component detection unit 13 classifies the component 3 in the road surface data 131 (S111). As the road surface classification processing S111, for example, a component indicated in the road surface data 131 is classified as the manhole 31 by using an image processing method such as contour detection or color detection.

Then, the underground structure detection apparatus 1 transmits the classification result of the components in the road surface data 131 and the position information and the shape information of the component 3 in the road surface data 131 to the component information processing unit 15 as the road surface detection data 202.

Next, the blueprint data component detection unit 14 classifies the components in the blueprint data 141(1) and 141(2) (S121). As the blueprint classification processing S121, for example, the components 3 in the blueprint data 141(1) are classified into the manhole 31 and the water pipe 33(1), and the components in the blueprint data 141(2) are classified into the manhole 31 and the water pipe 33(1), the water pipe 33(2).

Then, the underground structure detection apparatus 1 transmits the classification results of the components in the blueprint data 141(1) and 141(2) and the position information and the shape information of the components in the blueprint data 141(1) and 141(2) to the component information processing unit 15 as the blueprint detection data 203.

As the blueprint classification processing S121, for example, a framework for object detection may be used to calculate data of labels and positions of underground components. For example, at least one of a faster region-based convolutional neural network (Faster R-CNN) or a single short multibox detector (SSD) may be used as the framework for the object detection. Note that the blueprint classification processing S121 is not limited to calculating the type information, the position information, and the shape information of the components using a method such as Faster R-CNN and SSD, and the type information, the position information, and the shape information of the components may be detected using OCR.

Next, the component position/posture estimation processing will be described with reference to FIGS. 6 to 8B.

This processing corresponds to S106 in FIG. 5.

First, in the position/attitude estimation processing, it is determined whether the component is a “pipe” (S701). Here, the “pipe” is a concept including an embedded object protected by a tubular object such as a water pipe, a gas pipe, or the like, for example, an electric wire, and is intended for an object having a long extending shape installed so as to connect predetermined places.

Next, the direction of the pipe is checked on the basis of the result of the classification processing of the components in S105, and it is determined whether the extending direction is deviated from the direction (X-axis direction) in which the vehicle moves by a predetermined threshold angle or more in the X-axis direction or deviated from the width direction (Y-axis direction) of the vehicle by a predetermined threshold angle or more in the Y-axis direction (S702). In a case where the extending direction is deviated (S702: Yes), the process proceeds to S703. Otherwise (S702: No), the process proceeds to S704. As a precondition of this determination, most of these buried objects are provided in a direction in which the vehicle 2 travels, that is, under a road in parallel with an extending direction of the road, or in a width direction of the vehicle, that is, perpendicular to the extending direction of the road. Therefore, when this condition is not met, it is considered that there is a high possibility that the pipe posture detection is not correct as a result of the classification of the components of S105.

Note that the determination in S702 is not limited to the example in which the determination is made based on the angles of the components as described above. For example, in a case where the road surface has moisture (the color is dark) with reference to the road surface data 131, the process may proceed to S703. Furthermore, for example, with reference to the blueprint data 141, the process may proceed to S703 in a case where the posture is different from the posture of the buried object at the place. Furthermore, for example, in a case where data indicating position information such as GPS is attached to the detection data, the process may proceed to S703 in a case where there is a deviation of a predetermined threshold or more with reference to information of the same place in the past inspection.

Next, the three-dimensional model component detection unit 12 performs position/posture correction processing using the two-dimensional data (S703).

Note that details of this processing will be described later with reference to FIG. 7.

Next, the three-dimensional model component detection unit 12 stores the position/posture estimation result as the component analysis data 521 (S704).

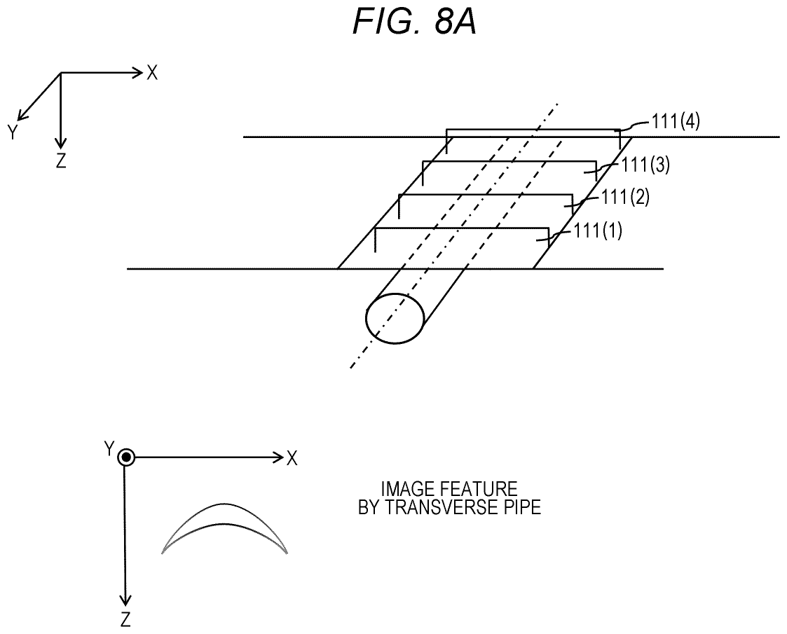

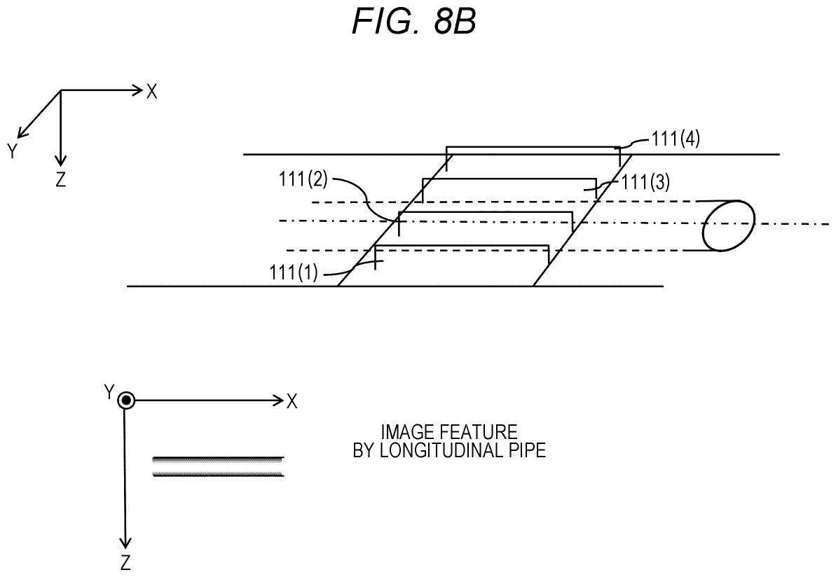

Next, details of the position/posture correction processing using two-dimensional data will be described with reference to FIGS. 7, 8A, and 8B.

This processing corresponds to S703 in FIG. 6.

First, the three-dimensional model component detection unit 12 determines whether or not an image feature (image feature of the transverse pipe) appearing when an object to be a component is in the transverse direction (x direction) is included in the two-dimensional image within the range of the target indicated by the classification result of the component (S801). In a case where there is the feature (S801: Yes), the process proceeds to S802. In a case where there is no feature (S801: No), the process proceeds to S805.

For example, as illustrated in FIG. 8A, in a case where the two-dimensional data 111(1) to the two-dimensional data 111(4) are included in the region of the buried object estimated by the three-dimensional classification processing, the feature of the transverse pipe is sequentially confirmed from the target region of the two-dimensional data 111(1) to the two-dimensional data 111(4), and it is determined as Yes in S801 when even one of the features is detected. The image feature of the transverse pipe includes a pattern indicating a quadratic curve shape in which the gradation of the luminance is convex upward as illustrated in FIG. 8A, and the detection method thereof is performed, for example, by comparing the degree of coincidence with a pattern prepared in advance. Since the size, width, and the like of the pattern change depending on the material and size of the buried object, a plurality of patterns to be prepared in advance may be prepared. Note that the X and Z coordinates may be recorded in the component analysis data 521 at the time of detection, or the features of all the transverse pipes included in the two-dimensional image within the target range may be detected.

Next, the three-dimensional model component detection unit 12 counts the number of pieces of two-dimensional data in which the feature of the transverse pipe overlaps and extends over the same position (S802).

For example, starting from the two-dimensional data 111(1), subsequently, for the two-dimensional data 111(2) to, it is determined whether an image feature of the transverse pipe seen in the two-dimensional data 111(1) is found, and the number thereof is counted. If there is a feature of the transverse pipe at substantially the same position (within a predetermined threshold range) as the coordinates at which the feature is detected in the two-dimensional data 111(1), the number of consecutive times is increased by 1 to confirm the next adjacent image, and the count is incremented. If there is no feature of the transverse pipe at the same coordinate position, the count of the number of consecutive times is stopped, and the present processing is terminated. In consideration of a case where the transverse pipe is installed in an oblique direction, it may be determined that the transverse pipe regions are continuous when the transverse pipe regions are common to a predetermined threshold or a predetermined ratio or more.

Next, the three-dimensional model component detection unit 12 determines whether or not the consecutive number of sheets determined to be at the same position is equal to or larger than a predetermined threshold value (S803). When the consecutive number of sheets is equal to or larger than the predetermined threshold (S803: Yes), the process proceeds to S804. When the consecutive number of sheets is less than the predetermined threshold (S803: No), the process ends. The predetermined threshold may be specified by, for example, a specific numerical value such as 3, or may be specified at a ratio such as 80% of the number of two-dimensional images to be checked. The reason why the determination is made on the basis of the number of continuous sheets is that, in the case of the transverse pipe, as illustrated in FIG. 8A, it is considered that the transverse pipe spreads over the entire width of the road, and when this image feature is only seen sporadically, it is considered that the buried object is a block-shaped buried object.

Next, the three-dimensional model component detection unit 12 corrects the detection result by the three-dimensional classification processing for the position/posture information of the component based on the information of the two-dimensional data having the image feature in the transverse direction (S804), and ends the processing.

For example, in a case where the image features of the transverse pipe are continuously detected from the two-dimensional data 111(1) to the two-dimensional data 111(4), the trajectories of the X and Z coordinate values of the points having the highest luminance among the features of the transverse pipe from the two-dimensional data 111(1) to the two-dimensional data 111(4) may be linearly approximated to obtain the posture of the transverse pipe. Furthermore, for example, in a case where a plurality of corresponding transverse pipes are detected, the transverse pipes may be replaced with a plurality of pieces of transverse pipe information.

If No in S801, the three-dimensional model component detection unit 12 determines whether or not the image feature of the vertical pipe is present in the two-dimensional data within the range (S805). In a case where the image feature is present (S805: Yes), the process proceeds to S806. In a case where the image feature is not present (S805: No), the process ends. The image feature of the longitudinal pipe includes, for example, a pattern in which a point with low luminance is sandwiched by a point with high luminance as illustrated in FIG. 8B, and the detection method includes, for example, comparing the degree of coincidence with a pattern prepared in advance. Note that the X and Z coordinates may be recorded in the component analysis data 521 at the time of detection, or the features of all the longitudinal pipes included in the two-dimensional data within the target range may be detected.

Next, the three-dimensional model component detection unit 12 counts the number of pieces of two-dimensional data in which the features of the longitudinal pipes overlap and extend over the same position (S806).

For example, starting from the two-dimensional data 111(1), subsequently, with respect to the two-dimensional data 111(2) to, it is determined whether or not the image feature of the longitudinal pipe seen in the two-dimensional data 111(1) is found, and the number thereof is counted. If there is a feature of the longitudinal pipe at substantially the same position (within a predetermined threshold range) as the coordinates at which the feature is detected in the two-dimensional data 111(1), the number of consecutive times is increased by 1 to confirm the next adjacent image, and the count is incremented. If there is no feature of the longitudinal pipe at the same coordinate position, the count of the number of consecutive times is stopped, and the present processing is terminated. In consideration of a case where the longitudinal pipe is installed in an oblique direction, it may be determined that the longitudinal pipe regions are continuous when the longitudinal pipe regions are common to a predetermined threshold or a predetermined ratio or more.

Next, the three-dimensional model component detection unit 12 determines whether the consecutive number of sheets determined to be at the same position is larger than or equal to a predetermined threshold (S807). When the consecutive number of sheets is larger than or equal to the predetermined threshold (S807: Yes), the process proceeds to S808. When the consecutive number of sheets is less than the predetermined threshold (S807: No), the process ends.

The reason for the determination based on the number of continuous longitudinal pipes is that, as illustrated in FIG. 8B, since the longitudinal pipe extends in the traveling direction of the vehicle 2, the number of continuous longitudinal pipes in the vertical direction is determined to be not a pipe shape but a buried object having a plate shape. Therefore, for example, the predetermined threshold may be set to a fixed value such as 2. Furthermore, in consideration of the extension in the oblique direction, the search range may be divided by a predetermined number of X coordinates, and it may be confirmed that the number of continuous images is less than or equal to a predetermined threshold for all the divided regions.

Next, the three-dimensional model component detection unit 12 corrects the detection result by the three-dimensional classification processing for the position/posture information of the component based on the information of the two-dimensional data having the image feature in the longitudinal direction (S808), and ends the processing.

For example, when the image features of the longitudinal pipe are continuously detected in the two-dimensional data 111(2) and the two-dimensional data 111(3), among the features of the longitudinal pipe in the two-dimensional data 111(2) and the two-dimensional data 111(3), the posture of the buried object is set by connecting end points of a region where pixels having luminance higher than a predetermined value are continuous in the extending direction. Furthermore, for example, in a case where a plurality of longitudinal pipes are detected in the corresponding region, the longitudinal pipes may be replaced with a plurality of pieces of transverse pipe information.

Next, the dimension adjustment processing will be described in detail.

This processing corresponds to S3 in FIG. 4.

As dimension adjustment processing, the dimension adjustment unit 151 causes coordinate systems between the respective pieces of data to correspond to each other before adjusting dimensions of the respective pieces of three-dimensional data 121, the road surface data 131, and the blueprint data 141. That is, the dimension adjustment unit 151 associates the road surface data 131 and the blueprint data 141 with the X, Y, and Z-axis directions of the three-dimensional data 121.

For example, the dimension adjustment unit 151 adjusts the dimension of the road surface data 131 based on (Formula 3) and (Formula 4) described below.

L2=r1*L (Formula 3)

H2=r2*H (Formula 4)

r1 and r2 are scales indicating a correspondence relationship between the three-dimensional data 121 and the road surface data 131. That is, r1 is the magnification in the lateral direction of the three-dimensional data 121 and the road surface data 131, and r2 is the magnification in the longitudinal direction of the three-dimensional data 121 and the road surface data 131.

Furthermore, the dimension adjustment unit 151 adjusts the dimension of the blueprint data 141(1) based on, for example, (Formula 5) and (Formula 6) described below.

L3=m1*L (Formula 5)

H3=m2*H (Formula 6)

m1 and m2 are scales indicating the correspondence relationship between the three-dimensional data 121 and the blueprint data 141(1). That is, m1 is a magnification in the lateral direction of the three-dimensional data 121 and the blueprint data 141(1), and m2 is a magnification in the longitudinal direction of the three-dimensional data 121 and the blueprint data 141(1).

Furthermore, the dimension adjustment unit 151 adjusts the dimension of the blueprint data 141(2) based on, for example, (Formula 5) described above and (Formula 7) described below. Note that in a case where the lateral dimension of the blueprint data 141(2) is set to another length different from the length L3, the dimension adjustment unit 151 may adjust the dimension of the blueprint data 141(2) using another formula different from (Formula 5).

W3=m3*W (Formula 7)

m3 is a scale indicating a correspondence relationship between the three-dimensional data 121 and the blueprint data 141(2). That is, m3 is a magnification in the depth direction of the three-dimensional data 121 and the blueprint data 141(2).

The coordinate integration processing of the dimension adjustment unit 151 will be described using the coordinates (x1, y1) of the manhole 31 illustrated in FIG. 3C of the road surface data 131 as an example. The dimension adjustment unit 151 adjusts the coordinates (x1, y1) of the manhole 31 of the road surface data 131 to other coordinates corresponding to the three-dimensional data 121. The dimension adjustment unit 161 adjusts the coordinates of the manhole 31 from (x1, y1) to (x1/r1, y1/r2) on the basis of (Formula 3) and (Formula 4) described above, for example.

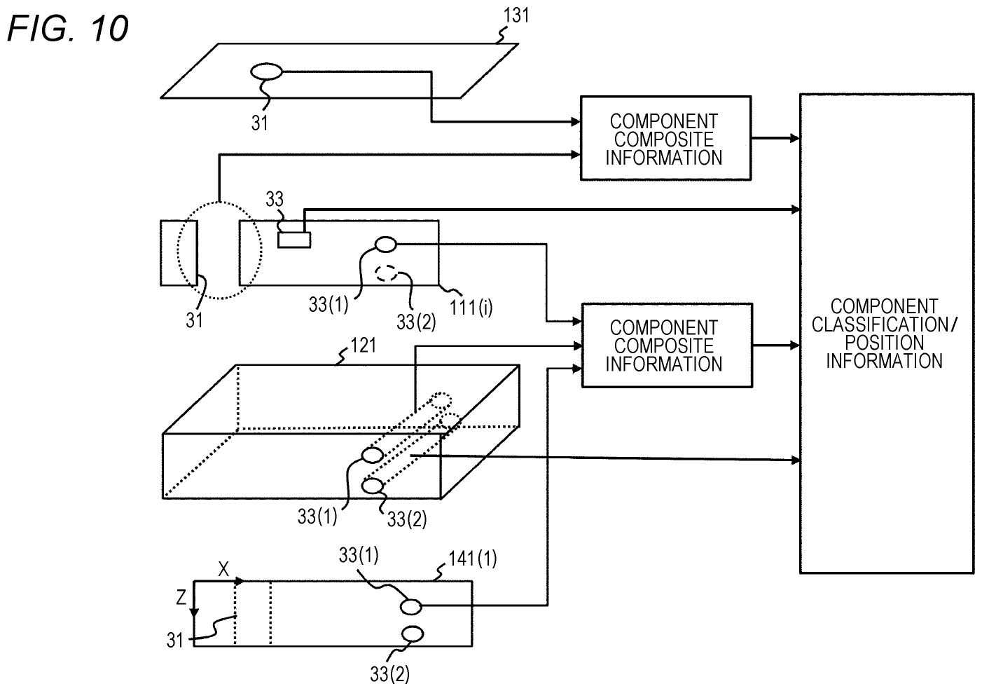

Next, the component specifying processing for the component composite information will be described with reference to FIGS. 9 and 10.

This processing corresponds to S5 in FIG. 4.

The component composite information generation unit 152 selects the same type pair among the components (S51). For example, the same type pair of pairs of the components 3 classified into the same type between the components in the two-dimensional data 111 and the components in the three-dimensional data 121 is selected. Specifically, as illustrated in FIG. 10, the component composite information generation unit 152 selects, for example, the water pipe 33(1) common to the two-dimensional data 111(i) and the three-dimensional data 121 as a pair of components.

Next, the component type specifying unit 154 of the component composite information generation unit 152 calculates a same type evaluation index that is an evaluation index between same type pairs of the components selected in the same-type pair selection processing S51 of the components (S52). For example, the component type specifying unit 154 calculates the same type evaluation index of the water pipe 33(1) in the two-dimensional data 111(i) and the water pipe 33(1) in the three-dimensional data 121 illustrated in FIG. 10 as “0.8”.

Note that, when calculating the evaluation index, the component type specifying unit 154 may use, for example, the degree of overlap (3D IoU: 3 Dimension Intersection over Union) between the selected pair of components. Furthermore, the component type specifying unit 154 is not limited to calculating the evaluation index on the basis of the degree of overlap between the selected pair of components, and may take a method of greatly evaluating the same type evaluation index when the numerical value of the corresponding dimension of each component has a high degree of approximation.

The component type specifying unit 154 of the component composite information generation unit 152 determines whether the same type pair indicates the same component based on the same type evaluation index (S53). For example, in a case where the same type evaluation index is larger than a predetermined threshold (S53: Yes), the component composite information generation unit 152 determines that the same type pairs indicate the same component (S54).

The predetermined threshold is a determination value as to whether the pair of components indicates the same component. For example, the predetermined threshold may be input to a component information display screen (described later) of the underground structure detection apparatus 1 by the user. For example, when the predetermined threshold is “0.7”, the component type specifying unit 154 determines that the water pipe 33(1) in the two-dimensional data 111(i) and the water pipe 33(1) in the three-dimensional data 121 illustrated in FIG. 10 indicate the same component.

The predetermined threshold may be set for each component. An input field for a predetermined threshold value may be displayed on a component information display screen (described later) displayed on the display device 61. The user may change the predetermined threshold and adjust the determination accuracy of the type of the component for each underground structure detection process.

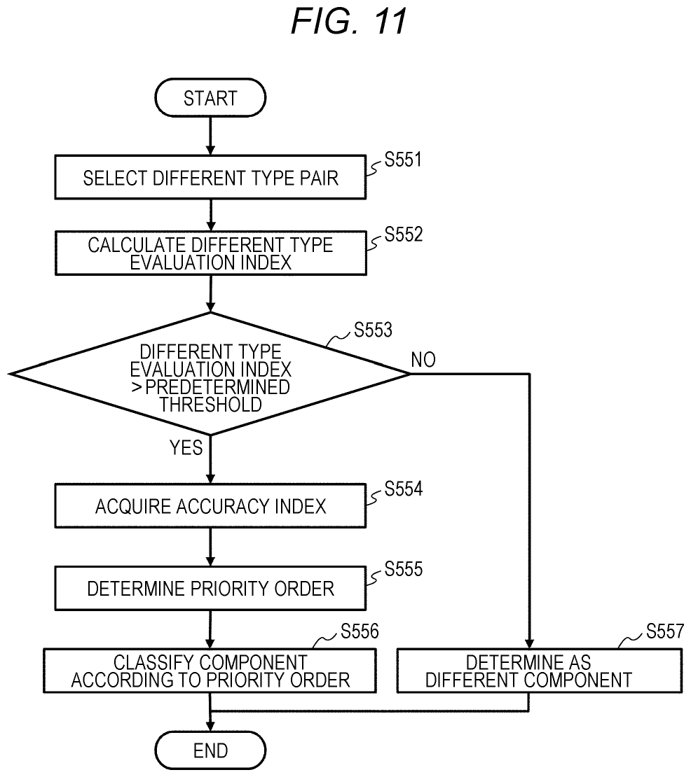

In a case where the same type evaluation index is less than or equal to the predetermined threshold (S53: No), the component type specifying unit 154 determines that same type component pairs indicate different components, and performs different type pair discrimination processing (S55). In this case, the component composite information generation unit 152 determines whether the same component is indicated between pairs of components classified into different types (hereinafter, referred to as “different type pair”). Details of the different type pair discrimination processing will be described later with reference to FIG. 11.

Note that in a case where the same type evaluation index is less than or equal to the predetermined threshold (S53: No), the component type specifying unit 154 may select the same type pair by executing the same type pair selection processing S51 again. That is, in this case, when the same-type evaluation index is less than or equal to the predetermined threshold (S53: No), the component type specifying unit 154 selects one of the same type pairs determined in S53.

Then, the component type specifying unit 154 newly selects a component classified into the same type as the selected one of the same type pairs, thereby selecting a new same type pair. The component composite information generation unit 152 may execute the different type pair discrimination processing S55 in a case where there is no component selectable as a new same type pair.

Finally, the component type specifying unit 154 records the analysis result regarding the type of the component in the component analysis data (S56).

Next, the different type pair discrimination processing of the component will be described with reference to FIG. 11.

This processing corresponds to S55 in FIG. 9.

The component type specifying unit 154 of the component composite information generation unit 152 selects a different type pair (S551).

In this processing, for example, the component type specifying unit 154 sets one of the same type pairs selected in the same type pair selection processing S51 as the predetermined component 3 and sets the other as the corresponding different type component.

The component type specifying unit 154 calculates a different type evaluation index which is an evaluation index of a different type pair (S552). In a case where the evaluation index is larger than the predetermined threshold value (S553: Yes), the component composite information generation unit 152 determines which of the different type pairs is to belong as the component of the component composite information (S554 to S556).

The different type evaluation index is an index for evaluating an index having a property opposite to that of the same type evaluation index.

The component type specifying unit 154 acquires the accuracy index from the three-dimensional model component detection unit 12, the road surface data component detection unit 13, and the blueprint data component detection unit 14 that have detected the different type pair (S554). For example, the accuracy index is an index indicating how accurate the classification result of the components is for each of the three-dimensional model detection data 201 output from the three-dimensional model component detection unit 12, the road surface detection data 202 output from the road surface data component detection unit 13, and the blueprint data output from the blueprint data component detection unit 14. The accuracy index is generated in, for example, the component classification processing by the three-dimensional model illustrated in FIG. 5 (S105), the component classification processing by the road surface data (S111), and the component classification processing by the blueprint data (S121), and is transmitted to the component information processing unit 15. The accuracy index can be calculated by obtaining a numerical value that highly evaluates a good result according to a learning model from past measurement data.

Next, the component type specifying unit 154 determines the priority order on the basis of the acquired accuracy index (S555). For example, the component type specifying unit 154 correctly classifies the component having the higher accuracy index (S556). That is, for example, the component composite information generation unit 152 determines that a component of which classification accuracy is low among the different type pairs is misclassified, determines that a component of which classification accuracy is high among the different type pairs is correct, and sets the classification as an analysis result.

In a case where the different type evaluation index is smaller than the predetermined threshold (S553: No), the component type specifying unit 154 determines that the different component is present (S557). Note that in a case where the different type evaluation index is smaller than the predetermined threshold (S553: No), the component type specifying unit 154 may perform the determination S553 of the different type evaluation index again by newly selecting a different type pair.

That is, the component type specifying unit 154 newly selects a component classified into a type different from the predetermined component from different type pairs of the predetermined component and another component, and performs the different type evaluation index determination S553 again according to the newly selected different type pair.

Next, an example of the component information display screen will be described with reference to FIG. 12.

The component information display screen 51 is a screen output in S7 of FIG. 4.

For example, the display unit 16 displays the three-dimensional model state display map 35 and the description field 36 of the component 3 (manhole 31, cavity 32, water pipe 33) on the display device 61 as the component information display screen 51.

The component information display screen 51 includes a three-dimensional state display map 35 and a component information display field 36.

The three-dimensional state display map 35 is an area that displays a shape and positional relationship of components in a three-dimensional space in a three-dimensional bounding box based on the component result data 522 which is a result analyzed by the underground structure detection apparatus 1.

The component information display field 36 is an area for displaying the type and coordinate data of each component. In the component information display field 36, for example, a type of buried object [center X coordinate, center Y coordinate, center Z coordinate, length, width, height] is displayed. Furthermore, in addition to the type and coordinates of the components, the component information display field 36 may display, for example, calculation results such as the length, width, and volume of the buried object and other supplementary information.

As described above, the underground structure detection apparatus 1 includes the component information processing unit 15, thereby detecting the component of the underground structure on the basis of the two-dimensional data 111, the three-dimensional data 121, the road surface data 131, and the blueprint data 141. As a result, the underground structure detection apparatus 1 can comprehensively detect the components of the underground structure, and can improve the detection accuracy of the underground structure as compared with the conventional method.

In particular, the underground structure detection apparatus 1 performs processing of correcting the position and posture of the component from the two-dimensional data 111 on the basis of the image features of the component with respect to the synthetic data obtained by synthesizing the two-dimensional data 111 and the three-dimensional data 121, and thus, it is possible to obtain an accurate position and posture.

Furthermore, the underground structure detection apparatus 1 can suppress dimensional deviation between data by performing the dimensional adjustment processing. As a result, the underground structure detection apparatus 1 can improve the detection accuracy of the components based on the three-dimensional detection data 201, the road surface data 134, and the blueprint data 144.

Furthermore, the underground structure detection apparatus 1 can automatically discriminate the type and the three-dimensional position of the buried object by the classification processing of the components. As a result, it is possible to reduce labor as compared with classifying components by human power.

Furthermore, the underground structure detection apparatus 1 determines which information of the heterogeneous pair is prioritized on the basis of the accuracy index, and thus, it is possible to suppress the data of the component having the wrong classification result from being captured. As a result, the underground structure detection apparatus 1 can improve the accuracy of classification of the components.

Furthermore, the underground structure detection apparatus 1 displays the type and position of the component on the component information display screen 51. This makes it easier for the user to understand what is at which position in the three-dimensional space.

Note that the underground structure detection apparatus 1 is not limited to generating information on the type and position of the component 3 on the basis of the two-dimensional radar data, the three-dimensional radar data, the road surface data, and the blueprint data. For example, even in a case where only the three-dimensional radar data and the road surface data are input, the underground structure detection apparatus 1 may detect the component of the underground structure by performing the same processing as described above.

### Second Embodiment

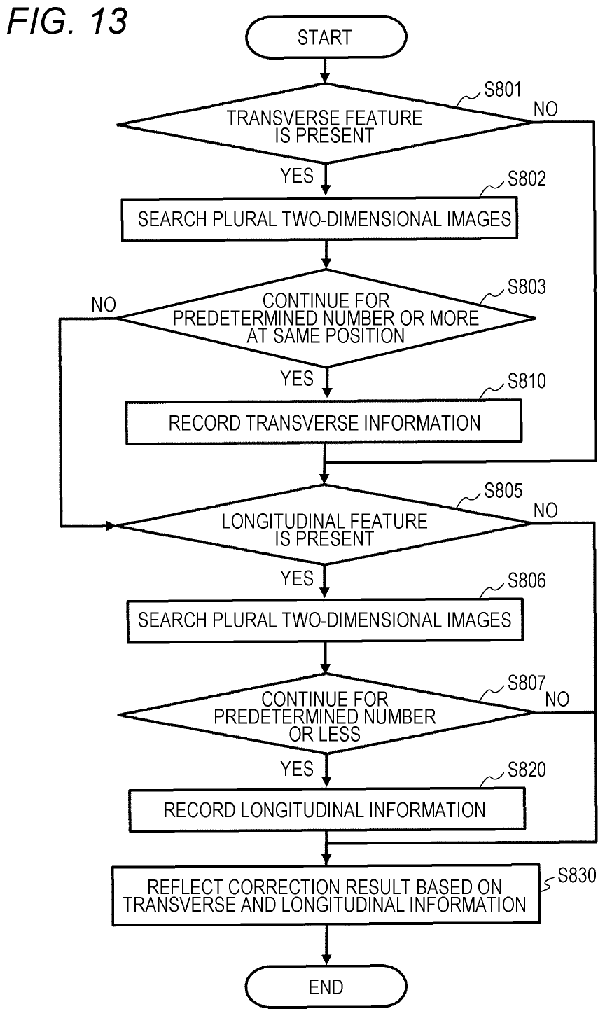

Hereinafter, a second embodiment of the present invention will be described with reference to FIG. 13.

Since the configuration and processing of the underground structure detection apparatus of the present embodiment are generally similar to those of the first embodiment, differences will be mainly described.

The present embodiment is different from the first embodiment only in the position/posture estimation processing according to the two-dimensional data of S703 of FIG. 6, and the processing of FIG. 13 is performed instead of the processing of FIG. 7 of the first embodiment. The difference from the processing of FIG. 7 of the first embodiment is that determination of both the transverse direction and the traveling direction is performed.

S801 to S803 are the same as those in the first embodiment.

In the present embodiment, when No is selected in S803, the process proceeds to S805, and when Yes is selected in S803, the transverse information is recorded in the component analysis data 521 (S810).

S805 to S807 are the same as those in the first embodiment.

A similar processing is performed, but in the present embodiment, when No is selected in S805, the process proceeds to S830.

If Yes in S807, information in the longitudinal direction is recorded in the component analysis data 521 (S820).

Finally, the correction result is reflected on the basis of the information regarding the position/posture of the component on the basis of the information in the transverse direction in S810 and the information in the longitudinal direction in S820. For example, in a case where the image characteristics of the transverse pipe continuous from the two-dimensional data 111(2) to (4) and the image characteristics of the longitudinal pipe are present in the two-dimensional data 111(1), both results are adopted and corrected. Furthermore, for example, in a case where the detection result of the longitudinal pipe intersects with a part of the detection result of the longitudinal pipe when it is assumed that the transverse pipe extends, information that there is a high possibility that intersection/branching occurs on the way may be included in the detection result.

In the correction processing using the two-dimensional data of the first embodiment, only one of the correction in the transverse direction and the correction in the traveling direction is performed. However, in the procedure of the present embodiment, image features in the transverse direction and the longitudinal direction are captured, and in some cases, both the correction in the transverse direction and the longitudinal direction may be performed. As a result, the three-dimensional model component detection unit 12 can detect the buried pipe having an L shape or a T shape whose cross section intersects the vertical pipe without error.

What is claimed is:

1. An underground structure detection apparatus that detects information including a component constituting an underground structure, a type of the component, and position/posture information based on a plurality of pieces of two-dimensional data indicating a cross section of ground and three-dimensional data indicating the underground structure, the underground structure detection apparatus comprising
a unit that, with respect to synthetic data obtained by synthesizing the two-dimensional data and the three-dimensional data, corrects the position/posture information of a component represented by the synthetic data based on an image feature grasped from the two-dimensional data.

2. The underground structure detection apparatus according to claim 1, wherein
a first determination condition is that an image feature indicated by the component in the two-dimensional data is included in continuous images by a predetermined first threshold or more according to a first direction, and when the first determination condition is satisfied, the position/posture information of the component represented by the synthetic data is corrected based on the two-dimensional data connected in the first direction, and
a second determination condition is that an image feature indicated by the component in the two-dimensional data is included in continuous images by a predetermined second threshold or less according to a second direction, and when the second determination condition is satisfied, the position/posture information of the component represented by the synthetic data is corrected based on the two-dimensional data connected in the second direction.

3. The underground structure detection apparatus according to claim 2, wherein
the component is a pipe,
the first direction is a transverse direction with respect to a road, and
the second direction is a longitudinal direction with respect to a road.

4. The underground structure detection apparatus according to claim 2, wherein a determination is made for both the first determination condition and the second determination condition.

5. The underground structure detection apparatus according to claim 2, wherein
the component is a pipe, and
when a determination is established for both the first determination condition and the second determination condition, information indicating that a type of the pipe is a T-shaped pipe or an L-shaped pipe is included and output.

6. The underground structure detection apparatus according to claim 1, comprising:
a unit that captures an image of a state of a road surface of a road to obtain road surface data; and
a unit that obtains blueprint data from a blueprint related to an underground structure,
wherein a type and a position of the component are obtained based on three-dimensional detection data obtained by detecting the component from the synthetic data obtained by synthesizing the two-dimensional data and the three-dimensional data, road surface detection data obtained by detecting the component from the road surface data, and blueprint detection data obtained by detecting the component from the blueprint data.

7. An underground structure detection method of an underground structure detection apparatus that detects information including a component constituting an underground structure, a type of the component, and position/posture information based on a plurality of pieces of two-dimensional data indicating a cross section of ground and three-dimensional data indicating the underground structure, the underground structure detection method comprising:
creating synthetic data obtained by synthesizing the two-dimensional data and the three-dimensional data;
determining, as a first determination condition, that an image feature indicated by the component in the two-dimensional data is included in continuous images by a predetermined first threshold or more according to a first direction with respect to the synthetic data obtained by synthesizing the two-dimensional data and the three-dimensional data;
correcting position/posture information of a component represented by the synthetic data based on the two-dimensional data connected in the first direction when the first determination condition is satisfied;
determining, as a second determination condition, that an image feature indicated by the component in the two-dimensional data is included in continuous images by a predetermined second threshold or less according to a second direction with respect to the synthetic data obtained by synthesizing the two-dimensional data and the three-dimensional data; and
correcting position/posture information of a component represented by the synthetic data based on the two-dimensional data connected in the second direction when the second determination condition is satisfied.

8. The underground structure detection method according to claim 7, wherein
the component is a pipe,
the first direction is a transverse direction with respect to a road, and
the second direction is a longitudinal direction with respect to a road.
